(19) United States
(12) Patent Application Publication
(10) Pub. No.: US 2007/0185879 A1
(43) Pub. Date: Aug. 9, 2007

(54) Systems and methods for archiving and retrieving digital assets

(75) Inventors: Nikolai Roublev, North Liberty, IA (US); Robert T. Long, Coralville, IA (US)

Correspondence Address: SCHWEGMAN, LUNDBERG, WOESSNER & KLUTH, P.A., P.O. BOX 2938, MINNEAPOLIS, MN, 55402, US

(73) Assignee: MetaCommunications, Inc.

(21) Appl. No.: 11/317,592

(22) Filed: Dec. 23, 2005

(51) Int. Cl. G06F 17/30

(52) U.S. Cl. 707/10

(57) ABSTRACT

Systems and methods provide a digital asset management system with archival and retrieval features. A database is synchronized with an online file system and maintains information related to files in the system. During an archiving operation, a user selects files to be archived, and a plurality of archiving parameters. The archiving parameters can include a media type and a data allocation scheme. Based on the archiving parameters chosen, the files are automatically allocated across one or more subfolders or “virtual media folders.” Each virtual media folder is a virtual representation of a specific removable media object (e.g. CD, DVD, tape, flash memory drive etc.) and is configured for subsequent copying to removable media. When a user wants to retrieve a digital asset that is no longer on the online file system, the system checks the media path and prompts the user to insert the removable media object of the same name.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright © 2004, 2005 MetaCommunications, Inc.

### FIELD

The present invention relates to systems for managing digital assets. More specifically, the present invention relates to archiving and retrieving of digital assets.

### BACKGROUND

Digital asset management (DAM) systems organize digital assets for storage, retrieval, and publishing. Digital assets, or digital resources, can be any type of file stored on a computer system, including image, video, or sound files. Many types of organizations, especially those involved in publishing, news, and advertising, devote considerable resources to creating and labeling the large amounts of digital assets that they produce. Short descriptions or thumbnails of digital content, i.e. metadata, are often assigned to each asset and stored in a database for convenient searching and management. Metadata allows users to search for files based on keywords, technical characteristics such as file type or size, or even legal status such as rights and credits. The metadata is typically linked to the actual digital asset (e.g. image or video file) that may be stored on a persistent storage system such as a shared server. With the rise of the Internet, many organizations have adopted DAM systems in order to save time and money.

For example, DAM systems provide efficiency by allowing a user to quickly retrieve existing digital assets that would otherwise be difficult or impractical to find, which may result in having to reproduce the digital asset. Thus, DAM systems allow for convenient reuse of previously completed digital assets, which allows for faster development and turnaround times. Furthermore, DAM systems yield more efficient and consistent workflows by providing automate improved tracking of the work process and fluid exchange of work among users. Throughout its lifecycle, digital assets typically require different degrees of availability, migration, retention, and access performance. In the initial stages of the development cycle data is often designated as being in “production.” Typically, a production folder comprises the files or jobs (i.e. digital assets) that are currently being worked on by various users in a shared environment. The data in production is constantly being modified by users in the form of additions, deletions, and revisions.

At the production stage there is a particular need for high availability, access performance, and protection. The production folder may be maintained on a shared fast file server that allows users to quickly open and save large files. However, space on a shared server is finite so there is a limit to the amount of digital assets that can be stored on the server. As the number of files stored on the server increases, users can experience greater difficulty in navigating the server and locating files. Over time, certain digital assets tend to become less critical and are accessed less frequently by users, depending on the development process and business requirements. As the server becomes full, the digital assets must typically be removed from the production folder on the server in order to make room for new files. However, it is not desirable to delete the displaced files because users often need to utilize them at some time in the future. As a result, digital assets are typically moved to an archive system that provides adequate qualities given the desired cost to benefit ratio. Such archiving presents time and cost challenges depending on the hardware required, the efficiency with which the archive can be searched, and the speed at which files can be accessed or retrieved.

One conventional method of dealing with this problem is to send production files to an archive server that is fully or incrementally backed-up to an offline storage system such as magnetic tape. However, due the vast amount of data that is usually involved, this process is often slow and complex. Moreover, in the event of a server failure or loss of data, restoring lost data requires all data from the back-up tapes to be restored. Another common offline storage method comprises saving digital assets such as production files to their local hard drive and then copies the files to CDs. This method is inconvenient and burdensome because the offline archive lacks an overall organization and users are unable to keep track of the name and location of the digital assets within the offline archive.

### SUMMARY

The embodiments of the present invention provide a digital asset management system for archiving and retrieval of digital assets. In particular, the various embodiments of the present invention utilize a database that is configured to provide functionality in the archiving and retrieval processes. The system receives a selection of digital assets for online archiving. The system provides a choice of archiving parameters, including the media type and the data allocation scheme. Based on the archiving parameters, the digital assets are allocated across one or more virtual media folders that are saved to a chosen destination in the online archive. The system assigns new file paths to each of the virtual media folders and records these paths in the database. Furthermore, the database may be updated to reflect the contents and organization of the virtual media folders as they appear on the online archive. The virtual media folders each function as a virtual representation of a specific type and size of removable media object to which the digital assets will be copied or otherwise saved for offline archiving. Once the digital assets have been copied to removable media, there may be two archive copies of the digital assets: a cache copy located in the user-selected destination folder on the online archive, and another copy located on removable media. As a result, no additional backup procedure is necessary, and the cache copy can be deleted from the online archive at the user's discretion. In this manner, the embodiments of the present invention generate an offline archiving scheme using a database to reflect the organization of the online file system and to access files regardless of whether they are on the online file system, the archive file system or on removable media.

A further aspect of the systems and methods includes receiving a retrieval request. The system first checks the file server path to see if the digital asset is available on the online archive. Even if the file has been removed from the online archive, its file server path will remain in the database. If the digital asset is on the online archive, the system finds it using its file server path and retrieves it for the user. However, if the digital asset is not found on the file server path, the system will check the media path recorded in the database, which will correspond to a virtual media folder.

### BRIEF DESCRIPTION OF THE DRAWINGS

FIG. 1 illustrates an exemplary embodiment of the present invention as implemented in digital storage management system.

FIG. 2 illustrates an exemplary embodiment of the present invention as implemented in digital storage management system.

FIG. 3 is an illustration of an exemplary archive parameter selection screen in accordance with embodiments of the present invention.

FIG. 4A depicts an exemplary pre-archive view of the database of embodiments of the present invention.

FIG. 4B depicts an exemplary post-archive view of the database of FIG. 4A.

FIG. 5 is an illustration of an exemplary offline archiving process in accordance with the database configuration shown in FIGS. 4A and 4B.

FIG. 6 is a flowchart illustrating an exemplary method of archiving data in accordance with embodiments of the present invention.

FIGS. 7A and 7B are flowcharts illustrating methods for retrieving archived data in accordance with embodiments of the present invention.

### DETAILED DESCRIPTION

In the following detailed description, reference is made to the accompanying drawings that form a part hereof, and in which is shown by way of illustration, specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the Figures, the same reference number is used throughout to refer to an identical component which appears in multiple Figures. Signals and connections may be referred to by the same reference number or label, and the actual meaning will be clear from its use in the context of the description.

The functions or algorithms described herein are implemented in hardware, and/or software in embodiments. The software comprises computer executable instructions stored on computer readable media such as memory or other types of storage devices. The term “computer readable media” is also used to represent software-transmitted carrier waves. Further, such functions correspond to modules, which are software, hardware, firmware, or any combination thereof. Multiple functions are performed in one or more modules as desired, and the embodiments described are merely examples. A digital signal processor, ASIC, microprocessor, or any other type of processor operating on a system, such as a personal computer, server, a router, or any other device capable of processing data including network interconnection devices executes the software.

Some embodiments implement the functions in two or more specific interconnected hardware modules or devices with related control and data signals communicated between and through the modules, or as portions of an application-specific integrated circuit. Thus, the example process flow is applicable to software, firmware, and hardware implementations.

Within this specification and as is known in the art, a folder may also be referred to as a directory. A folder or directory may hold a collection of zero or more files and/or other folders or directories, which may be referred to as subfolders or subdirectories.

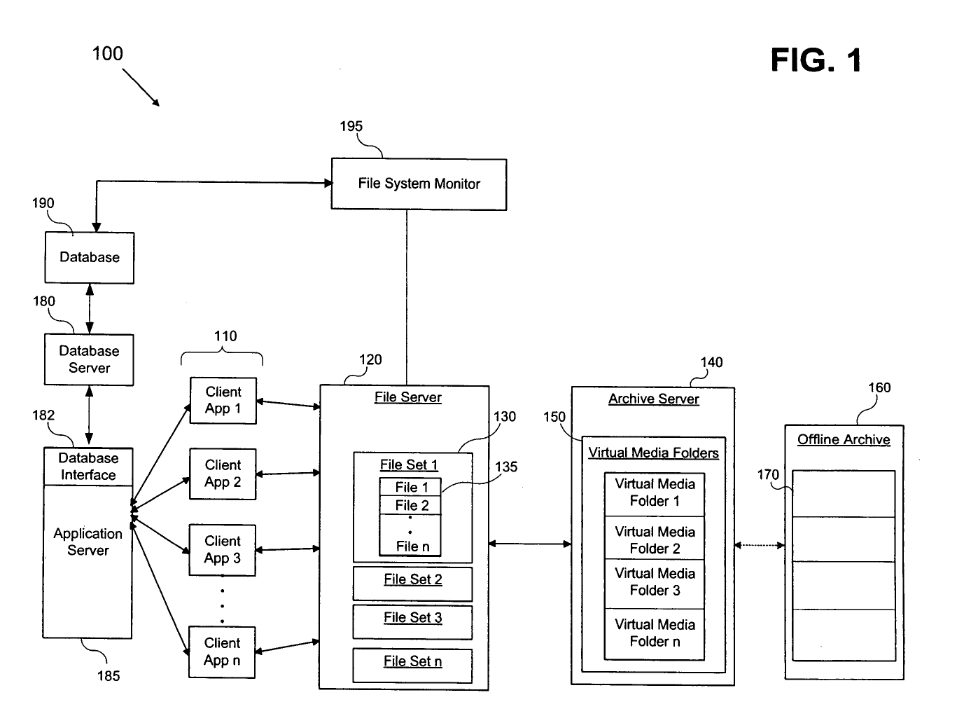

FIG. 1 illustrates an exemplary embodiment of the present invention as implemented in digital storage management system 100. In some embodiments, digital storage management system 100 comprises client applications 110, file server 120, archive server 140, offline archive 160, application server 185, database server 180 and database 190. In alternative embodiments of the invention, system 100 further includes a file system monitor 195. File server 120 is an online file storage device and typically provides fast access to files located on the file server. File server 120 may be used to store files 135.

Archive server 140 is also typically on on-line file storage device. Archive server 140 typically provides for greater storage capacity than file server 120. As an example, archive server 140 may be a network attached storage system, a storage area network, or other type of large file storage system.

Archive server 140 further comprises one or more virtual media folders 150. Virtual media folders each function as a virtual representation of a specific type and size of removable media object to which the digital assets will be copied or otherwise saved for offline archiving. Because it is an online archive, the contents of archive server 140 can be readily accessed by users operating client applications 110.

Offline archive 160 is typically an offline device. For example, offline archive 160 may comprise removable media storage device 170, which can be a jukebox or media storage cabinet that stores, for example, CDs or DVDs, magnetic tape (e.g., DAT, DLT etc), flash memory drives, USB attached drives or FireWire (i.e. IEEE 1394 networking standard) attached drives. Offline archive 160 can be a local or remote archive repository.

Client applications 110 can comprise one or more software applications that accesses data in database 190 via application server 185.

Application server 185 manages load distribution for the various client applications 110, and provides a database interface to database 190 to client applications 110. In some embodiments, the database interface is an ODBC (Open Database Connectivity) compliant database interface.

In those embodiments including a file system monitor 195, database server 180 is communicably coupled to file system monitor 195. File system monitor 195 synchronizes database 190 with file server 120 through database server 180 so that database 190 reflects the organization of the online file system. In an exemplary embodiment of the present invention, database 190 can be a relational database. In alternative embodiments, database 190 may be an object oriented database. In further alternative embodiments, database 190 may be a hierarchical database, for example an XML database.

Client applications 110, i.e. client applications 110.1-110.n, operate in a shared environment which allows each of client applications 110 to communicate with file server 120. Users controlling client applications 110 typically work with sets of interrelated digital assets called a projects or “jobs.” A “job” may incorporate a logical collection of files or folders. These logical collections will be referred to as a file set 130. The files 135 in a file set 130 typically comprise digital assets such as audio files, video files or image files associated with a job. Users controlling client applications 110 can each be working on one or more jobs, and each job can contain many digital asset files distributed in single folders or across multiple folders. For example, files 135 in file set 130 could be a magazine publishing project that further comprises hundreds of digital image files that constitute parts of the magazine. However, it must be noted that files in a file set need not be tied to a particular job, and a file set may comprise any grouping of files or folders. Throughout the data lifecycle, digital storage management system 100 utilizes database server 180 to store important information related to the content, data status, and location of all digital assets in the system in database 190. Data status can indicate whether the data is currently in production or in archive, while the location indicates the data's file path within the system. Database 190 can include information in the form of metadata, pointer data, and thumbnails.

In some embodiments, database 190 includes data fields used to replicate the structure of file server 120 via information received from file system monitor 195 such that database 190 accurately reflects the content, data status, and location of job-related digital assets. For example, file system monitor 195 continually monitors changes in file server 120 by performing operations such as automatic scan cataloguing. The automatic scan cataloguing may comprise periodically checking the file system, or may comprise checking a journal of file system activity. Whenever users operating client applications 110 modify a file in some manner (e.g. data status, content, or location) this modification is detected by file system monitor 195 and database 190 may be updated to reflect the modification.

Digital storage management system 100 tracks the data status of each digital asset by assigning a data status of“production” or “archive” to each digital asset, and maintaining this information in database 190. At the beginning of the development cycle, data is said to have production status. Typically, files in production, e.g. files 135 in file set 130, may be frequently created or altered in some manner as users at client applications 110 make deletions, revisions, and additions to the data in those files. As a result, the production stage of development typically demands high availability, access performance, and protection. These characteristics may be met by file server 120. Digital storage management system 100 of FIG. 1 illustrates an implementation of embodiments of the present invention in which all digital assets (e.g. files, folders, or jobs) are in production, and there are no digital assets in archive. Therefore, virtual media folder 150 of archive server 140 is empty, as is offline archive 160.

File set 130 contains files 135, which comprise files that are currently available on file server 120. Files 135 may be organized in a single directory, a directory and subdirectories, or across multiple directories. In some embodiments, files 135 may be organized according to the file set they belong to. By way of example, file set 130 of FIG. 1 includes files 1-n. Users operating client applications 110 can alter and update the contents of files 135 in file set 130 via their online connection to file server 120. When certain data in production becomes less critical and less frequently used over time, as dictated by the development process and business requirements, users operating client applications 110 can move the data out of production and into archive. For example, a user operating a client application 110 can move file sets 130 from file server 120 to archive server 140. In those embodiments including a file system monitor, the change may be detected by file system monitor 195 when it scans file server 120 for changes, and database 190 would be updated accordingly.

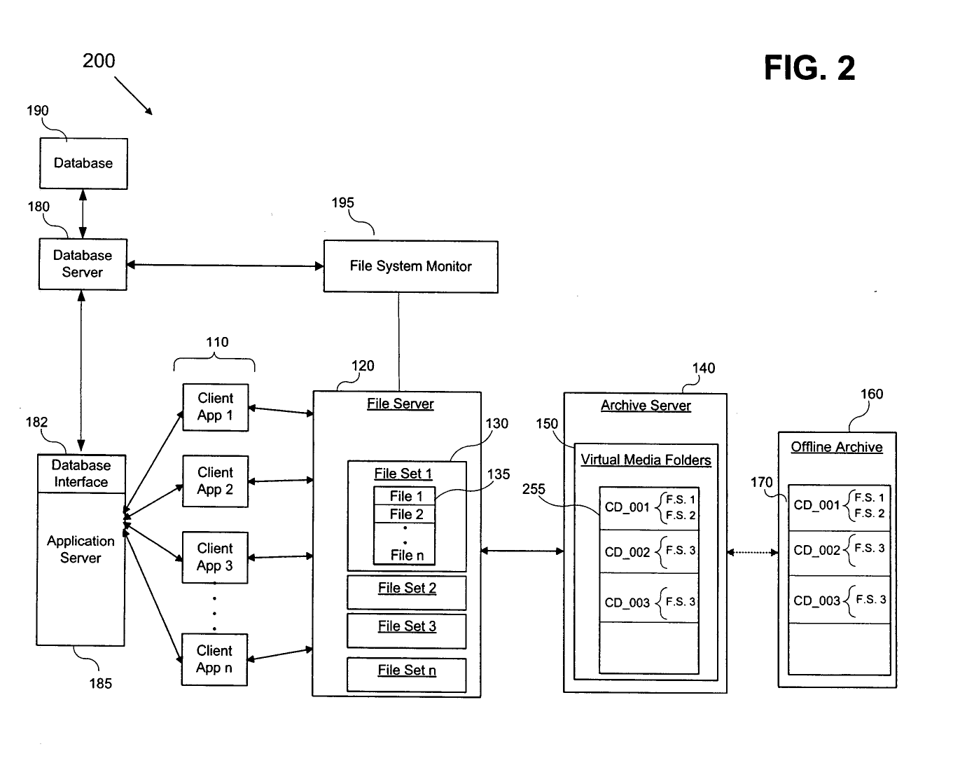

Referring to FIG. 2, digital storage management system 200 illustrates an exemplary embodiment of the present invention wherein file sets 1 through 3 have been selected for archive. More specifically, file sets 1 through 3 have been copied to an online archive, i.e. virtual media folder 150 of archive server 140. From archive server 140, file sets 1-3 have been copied to removable media, in this example CDs 1-3 of offline archive 160. Other file sets (e.g. file sets 4-n) may remain in on file server 120 depending on the availability of disk storage. Because file server 120 has a limited amount of storage space, the removal of file sets 1 through 3 from file server 120 frees up space on that server for new files and file sets and provides for easier navigation. A file set or file is typically archived when users operating client applications 110 expect no further modifications to be made to its contents such that the data can be put in a final, read-only state. This can occur, for example, when the work product embodied in the production job has been delivered and the customer order is complete.

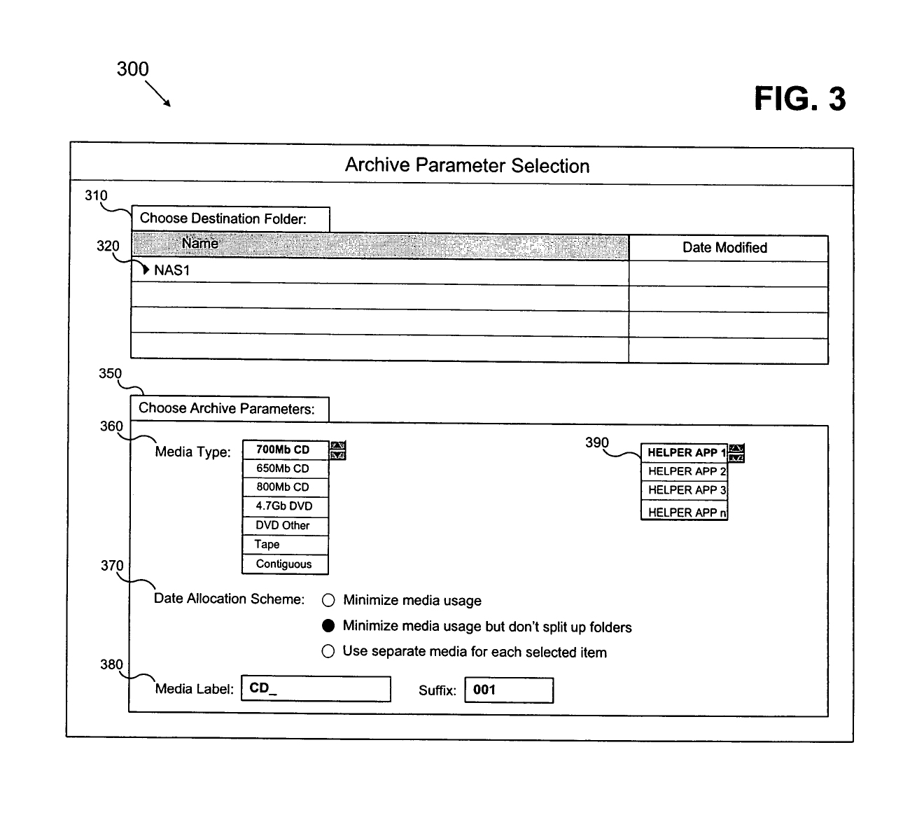

When a user selects digital assets for archiving, (file sets 1 through 3 in the example shown), the user is given a choice of archiving parameters that will determine the location and manner in which the data will be copied to the archive server. The archiving parameters include the destination folder on the archive server to which the data is to be archived, and the data allocation scheme that is to be applied. The selection of archiving parameters and their effect is discussed below in the description of FIG. 3. In the exemplary embodiment of FIG. 2, the user has selected file sets 1-3 to be archived to virtual media folders 150 on archive server 140. Upon archiving, all of the contents of file sets 1 through 3 are moved from file server 120 to virtual media folders 150 on archive server 140. The system then changes the status of files 135 in file sets 1-3 from production to archive in database 190. Files in file sets 1 through 3 can be readily and directly accessed by users operating a client application 110 via archive server 140. Archive server 140 can act as an intermediate storage location, or cache, that assists in the preparation of data for subsequent offline archiving as described below. Thus, the copies of file sets 1-3 on archive server 140 can be referred to as cache copies. When files in file sets 1 through 3 are copied to archive server 140, the files and folders in the file set are automatically organized in a manner suitable for subsequent archive to offline archive 160. The internal organization of archive server 140 is configured in a manner that is suitable for recording to removable media. This internal organization may be recorded in database 190. In those embodiments including a file system monitor 195, the file system monitor may detect the changes and moves from file server 120 to archive server 140 and update database 190 accordingly.

As mentioned previously, a file set can contain a plurality of digital files of various types. As a result, there can be considerable variance between the file set sizes, i.e. the amount of data contained in each file set. Depending on the size of a file set, its contents may need to be divided into multiple archive file sets and distributed across multiple media units. For example, in the case of a CD backup media, a file set containing only 75 megabytes (Mb) of data will only take up a small percentage of a CD, while another file set could contain 7500 Mb and require multiple CDs to store all of the files in the file set. According to the archiving parameters selected by the user, the system labels each file set and assigns each file set to a reserved location within virtual media folder 150. The file sets in virtual media folder 150 correspond to the content of removable physical media. In some embodiments, the same names used by archive server 140 to label file sets is subsequently used to label the corresponding media. When file sets 1 through 3 are archived to offline archive 160, the allocation of the file sets across the backup media in removable media storage device 170 is determined by a data allocation scheme that depends on the size of the file sets, the size of the selected archive media, and whether folders are allowed to be split across multiple archive media.

In the example shown in FIG. 2, the user has selected CDs as the removable media, and the contents of file sets 1 and 2 are small enough to be stored on a single CD and are thus stored in a virtual media folder named CD_001, whereas file set 3 is too large to be stored on a single CD and is thus stored across multiple virtual media folders named CD_002 and CD_003. The particular distribution of file sets 1 through 3 across multiple virtual media folders depicted in FIG. 2 is only one of many possible configurations as dictated by the amount of data contained in each file set. For instance, the contents of file sets 1 through 3 may all fit on CD_001, or alternatively, the contents of file set 1 may need to be distributed across CD_001, CD_002, and CD_003. Users typically have a choice about what to do with the file sets that are now stored in both archive server 140 and offline archive 160. Users operating a client workstation 110 can opt to leave all or a portion of file sets 1 through 3 in archive server 140 (until deletion is required as file storage space nears capacity on archive server 140), or can opt to have all or a portion of file sets 1 through 3 deleted from archive server 140 after the files have been copied to the selected removable media type. The copying of file sets 1 through 3 to offline archive 160 and subsequent removal from archive server 140 frees up space on archive server 140 and can provide for easier navigation of that server. Alternatively, digital storage management system 200 can be configured to perform automatic deletion of files from archive server 140 once they have been copied to offline archive 160. Upon deletion from archive server 140, the removable media becomes the archive copy for the file sets.

In some embodiments, the digital storage management system also facilitates retrieval of archived file sets or files in response to user requests. Referring to FIG. 2, users operating client applications 110 can make file set retrieval requests based on data status, data location, or other criteria found in database 195. To perform a user retrieval request, a user enters retrieval criteria. The contents of database 195 are then searched to determine the location of the file. Digital storage management system 200 first searches database 190 to determine if the requested file or files are located on file server 120. If the database 190 indicates the file is not on file server 120, the system then searches the database to determine if the file is in a virtual media folder 150 of archive server 140. If the database indicates that the requested file or files may be found on either file server 120 or archive server 140, the user can immediately access the file via the file path maintained in the database. If the database indicates that the requested file is not found on file server 120 or archive server 140, the system determines that the file or files are not available online and that the file has been copied to offline storage, e.g. copied to the recordable media of offline archive 160. The user is informed of the exact location of the file within removable media storage device 170 of offline archive 160, i.e. which removable media unit and which file set the file resides in. If client application 3 makes a request to retrieve a file in file set 2, database 190 will inform the client application that the file is located in file set 2 on CD_001. Retrieval of files in the manner described above provides improved speed and reliability in the file retrieval process. Instead of searching for a requested file in the file server 120 and the archive server 140, digital storage management system 200 only requires a search of the centralized information contained in database 195. Such a database search is considerably faster and more reliable that performing a search through the online servers such as file server 120 or archive server 140.

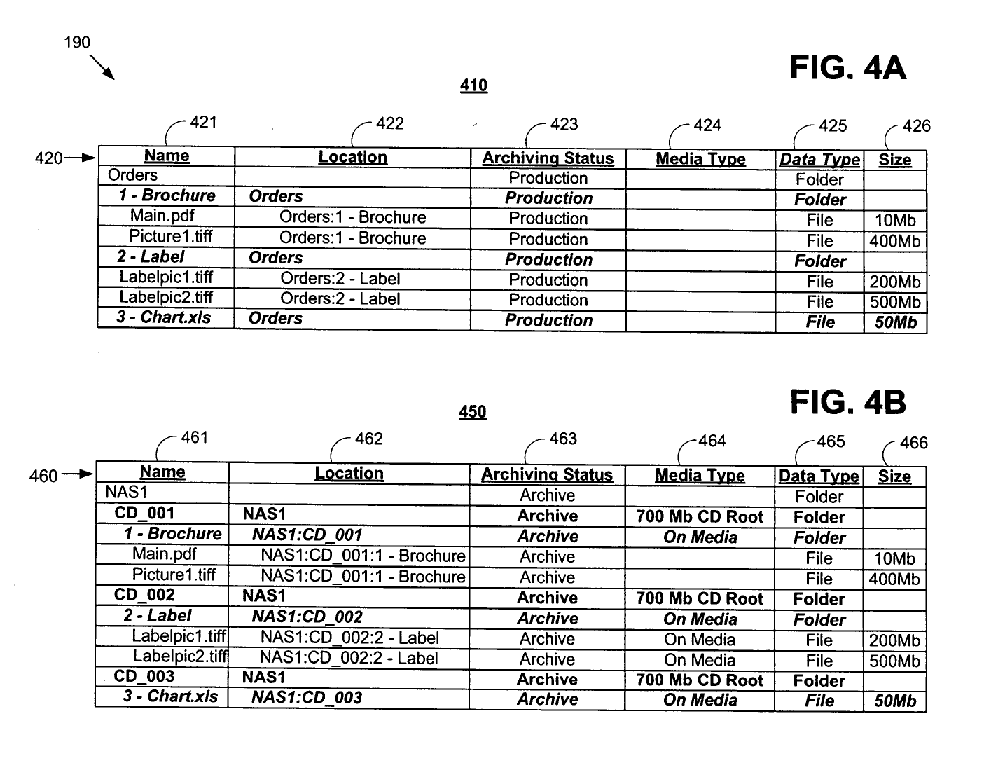

Referring to FIG. 3, archive parameter selection screen 300 is an exemplary illustration of the archive parameter selection screen that is presented when a user selects digital assets for archiving. The exemplary selections (shown in bold) made in archive parameter selection screen 300 correspond to post-archive database 450 of FIG. 4b, i.e. the archive parameters chosen in archive parameter selection screen 300 produce the archive configuration shown in post-archive database 450 of FIG. 4b. Archive parameter selection screen 300 can present the user with a variety of archiving options. First, using the destination folder window 310, a user can browse the various folders on the file system and click on the desired destination folder 320 to which the selected digital assets will be archived. For example, in archive parameter selection screen 300, the destination volume “NAS1” has been chosen as the volume on which virtual media folders on the archive server will be created. As a result, all selected digital assets will be archived to the “NAS1” volume, as shown below the Name 461 column in post-archive database 450 of FIG. 4B. Next, the user can select from among the archive options presented in archive parameter window 350. The archive parameters chosen within archive parameter window 350 will determine the name, size, and organization of the virtual media folders described above in connection with post-archive database 450 shown in FIG. 4B. Archive parameter window 350 allows the user to select the media type 360, the data allocation scheme 370, and the media label 380.

As shown in FIG. 3, the media type can be selected from among a plurality of options provided in the adjacent drop-down menu. The media type refers to the type of removable media that the digital assets will be archived to offline, e.g. CD, DVD, or Tape or other removable archive media. The data storage capacity can be a further determinant of the media type 360. For example, a user can select 650 Mb CD, 700 Mb CD, or 800 Mb CD. In the example illustrated in FIG. 3, the media type selected in archive parameter selection screen 300 is 700 Mb CD. As a result, the system will allocate the digital assets selected for archive across 700 Mb virtual media folders, as shown under the media type column 424 of post-archive database 450 of FIG. 4b. The user can also select the data allocation scheme 370, which determines the manner in which the digital assets will be divided and distributed across multiple removable media as required. For the purposes of the present discussion it will be assumed that multiple removable media are required, i.e. the digital assets selected for archive exceed the storage capacity of a single 700 Mb CD.

A first option is to minimize media usage without regard to whether folders have to be split up across two or more removable media. A second option is to minimize media usage to the extent possible without splitting up folders across multiple removable media. This second option simplifies retrieval of a folder by minimizing the number of removable media objects that must be retrieved in order to access a folder and keeping the folder intact on a single removable media object whenever possible. This second data allocation scheme, i.e. the simplification of folder retrieval, has been chosen in the exemplary embodiment of FIG. 3, as indicated by the darkened radio button. The third data allocation scheme shown, i.e. “Use separate media for each selected item,” will allocate each selected digital asset to a separate removable media object. Although the data allocation scheme 370 chosen in FIG. 3 is not explicitly indicated in post-archive database 450 of FIG. 3, it is evident from the size and distribution of the digital assets across virtual media folders CD_001, CD_002, and CD_003 in FIG. 4b. Finally, the user can select the media label and suffix, which together designate the name of the virtual media folder where the digital assets will be contained, as well as the name of the specific removable media object that the digital assets will be stored. As shown in FIG. 3, the media label “CD_001” has been selected, which corresponds to the CD_001 folder shown in post-archive database 450 of FIG. 4b. The system automatically designates as many subsequent 700 Mb CDs as are required to complete the archiving process. The subsequent 700 Mb CDs are labeled by sequential numbering of the suffix. For example, if the user designates the media label as “CD_001,” and two more 700 Mb CDs will be required to accommodate the selected digital assets, then the subsequent CDs will be labeled “CD_002” and “CD_003” as shown in post-archive database 450 of FIG. 4B.

A further option is to select an archive helper application from helper application interface 390 in order to archive file sets. An archive helper application is an application that provides an intermediate archiving interface between a client application 110 and the archive media itself. For example, archive helper applications may aid in archiving file sets to tape media by maintaining a database of which files have been archived to tape, and the tape labels assigned to the tapes. One example of an archive helper application is the ARCserve® application available from Computer Associates International, Inc. of Islandia, N.Y. Thus rather than the system directly archiving files to a removable media, the helper application is informed of which files to archive, and the helper application then performs the archive functions. The archive helper application may assist in archiving file sets to tape, CD, DVD or any other type or removable media. In addition, the helper application may perform an immediate backup or it may schedule a backup to be performed at a future time. In some embodiments, the helper application creates a “job file” that contains parameters the control when and/or how the file set is to be archived to the backup media.

In the examples illustrated in FIGS. 2 and 3, the removable media comprises a CD. It should be noted that any type of media may be used as a backup media in addition to or instead of a CD. Such media include DVDs, magnetic tape (e.g., DAT, DLT etc), flash memory drives, USB attached drives, FireWire attached drives or other removable media no known or developed in the future.

FIGS. 4A and 4B illustrate entries and fields in, database 190 and how the database of the various embodiments adapts in response to an archiving operation in which a user moves selected digital assets from production to archive. Because database 190 is synchronized with the online file system, the fields and entries of database 190 always reflects that of the online file system. FIGS. 4A and 4B illustrate database 190 at different points in time. FIG. 4A illustrates an exemplary view of database 190 prior to archiving, i.e. pre-archive database 410. Correspondingly, FIG. 4B illustrates database 190 after the archiving operation has been performed, i.e. post-archive database 450. The contents, configuration, and names shown in databases 410 and 450 are provided only by way of example for the purpose of illustrating an exemplary archiving operation. The top row of database 410, i.e. digital asset parameters 420, indicates the various types of information recorded by database 190. The digital asset parameters 420 includes the name 421, location (i.e. path) 422, archiving status 423, media type 424, data type 425, and size 426 of various digital assets. The archiving status value of “Production” indicates that the files are currently resident on file server 120.

Referring to FIG. 4B, post-archive database 450 depicts an exemplary post-archive view of pre-archive database 410. As with pre-archive database 410, the top row of post-archive database 450 indicates the various types of information recorded by database 450, i.e. digital asset parameters 360. The digital asset parameter 460 includes the name 461, location 462, archiving status 463, media type 464, data type 465, and size 466 of various digital assets. In other embodiments, however, database 190 can include other digital asset parameters not shown or described herein. As indicated by the archiving status 463, all the digital assets in post-archive database 450 are currently in archive. It should be noted that a database will have a mixture of files resident on file server 120, archive server 140, and on removable media 160, thus the database will be a mixture of the types of entries illustrated in tables 410 and 450.

Further, in some embodiments, a single entry is used to indicate that a file has been archived, regardless of whether the file has been archived to archive server 140 or to removable media 160. In these embodiments, if the file has been archived to removable media, the location field 462 will be interpreted to determine a mount point for the removable media. Thus in the example illustrated in FIG. 4B, CD_001, CD_002 and CD_003 are mount points for their respective removable media, and are also folders on volume NAS1 on an archive server.

In alternative embodiments, two entries may exist for archived files if the file has been copied to removable media but still exists on archive server 140. One entry is a path to the file on the archive server, while the other entry indicates the mount point for the removable media.

As mentioned previously, the database used in some embodiments of the present invention, e.g. database 190, is synchronized with the online file system and is updated to reflect the online file system whenever a digital asset is modified. When a digital asset is modified in the file system, the appropriate digital asset parameter 310 is updated to reflect the change. As indicated by the archiving status 423, all the digital assets in pre-archive database 190 are currently in production. The digital assets shown in pre-archive database 190 are contained in the folder entitled “Orders” which contains a total of two subfolders and five files. The folder entitled “Orders” comprises subfolders “1-Brochure” and “2-Label,” and file “3-Chart.xls.” Folder 1-Brochure further comprises files “Main.pdf” and “Picture1.tiff.” Folder 2-Label further comprises “Labelpic1.tiff” and “Labelpic2.tiff.” Finally, there is the file entitled “Chart.xls.” The size of each file is indicated by size 426. For example, the main.pdf file is 10 Mb. When the digital assets of pre-archive database 410 are selected by the user and are archived, the appropriate digital asset parameters are automatically updated to reflect this change as shown in post-archive database 450 of FIG. 4b. Furthermore, the archived digital assets in post-archive database 450 are organized into a specific, advantageous manner as described below.

When a user selects one or more files or folders for archive (folder 1-Brochure, folder 2-Label, and file Chart.xls in this example), some embodiments of the present invention prompt the user to select certain archive parameters. In particular, the archive parameters can include the media type and the data allocation scheme. The “media type” refers to the type of removable media that the user wants the digital assets to be archived to offline, e.g. 650 Mb CD, 700 Mb CD, 750 Mb CD, or 4.7 Gb DVD, tape or other removable media. Assuming that the selected digital assets will not fit on one piece of removable media, the data allocation scheme determines the method by which the selected digital assets will be distributed across multiple pieces of removable media. Numerous data allocations schemes can be available to the user. For example, a first data allocation scheme can be based on a preference for minimizing removable media usage for the selected digital assets. Another data allocation scheme can be based on keeping folders intact, i.e. not splitting up folders across multiple removable media unless necessary. Finally, a third data allocation scheme can be based on using separate removable media for each digital asset selected. Depending on the user's needs, the user selects a data allocation option.

Based on the selected archiving parameters, the selected digital assets are organized into “virtual media” folders on the online file system. Simultaneously, the database generates its own representation of the file system, e.g. database 450. As used herein, these folders are referred to as “virtual media” because they function as a virtual representation of a particular removable media. That is, each virtual media is customized for being copied to a specific removable media object. Referring to FIG. 4b, post-archive database 450 shows that the digital assets 1-Brochure, 2-Label, and 3-Chart have been allocated across three virtual media folders, i.e. CD_001, CD_002, and CD_003. These virtual media folders are located under the “NAS1” folder on the online file system, e.g. they have been archived to an online archive server such as archive server 240 of FIG. 2. Once these virtual media folders are generated, each digital asset has two file paths that are stored on the database: a “file server path” and a “media path.” The file server path refers to the location on the online file server, while the media path refers to the location on offline removable media.

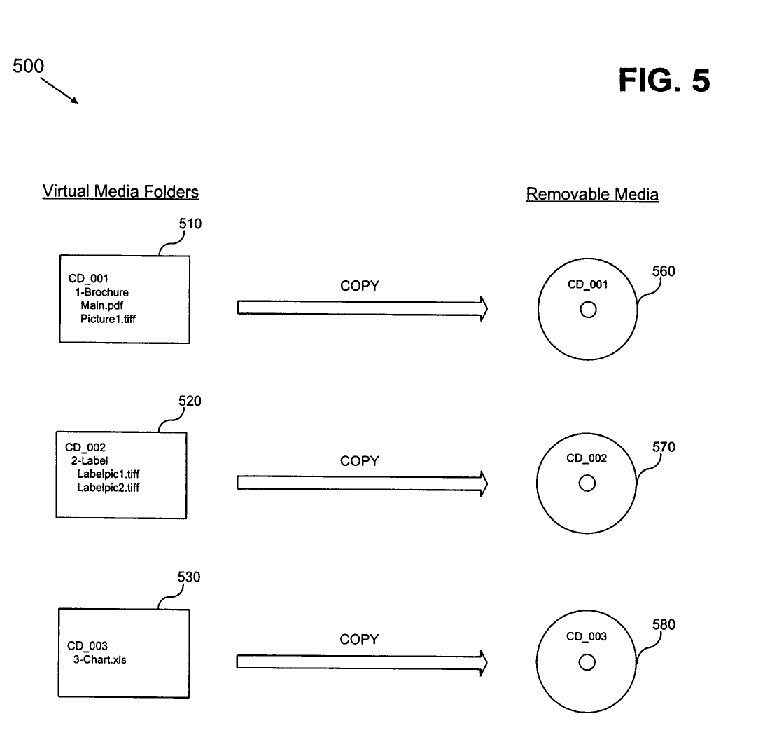

For example, with respect to folder 1-Brochure, “NAS1” refers to the file server volume, and CD_001 refers to the pathname for the virtual media folder. In this case, the user has selected the media type as 700 Mb CD, as indicated by the media type 464 of post-archive database 450. Furthermore, the data allocation scheme was selected so that folders were not split up across multiple CDs. That is, the 200 Mb file Labelpic1.tiff could have been allocated to virtual media folder CD_001 because 290 Mb of free space remains on that CD. This would have resulted in more efficient usage of the space available on the removable media. However, the user may have decided that not splitting up folders was more important than minimizing media usage, and thus did not want to split up folder 2-Label across CD_001 and CD_002. Virtual media folders CD_001, CD_002, and CD_003 each correspond to a specific removable physical media CD with the same label. The user can copy the contents of each virtual media folder to its corresponding removable media CD as discussed in the description of FIG. 5.

Referring to FIG. 5, offline archiving process 500 illustrates an exemplary process of archiving from an online archive to offline removable media in accordance with the database configuration of FIG. 3. Virtual media folders 510, 520, and 530 correspond to virtual media folders CD_001, CD_002, and CD_003 of post-archive database 450 of FIG. 4b, respectively. Accordingly, removable media CDs 560, 570, and 580 are all 700 Mb CDs, as chosen by the user and indicated by the media type 424 of FIG. 4b. From the online file system, the user can simply click and drag virtual media folder 510 to corresponding removable media CD 560 to initialize the process of saving or copying the files in folder 510. The result is that removable media CD 560 will contain an identical copy of the contents and organization of virtual media folder 510 as it exists on the online file system and database. Similarly, virtual media folders 520 and 530 can be copied to removable media CDs 570 and 580, respectively. Once virtual media folders CD_001, CD_002, and CD_003 have been copied to their three corresponding CDs, the CDs can be placed within a removable media storage device such as a media storage cabinet or jukebox. At this point there are two archive copies of the digital assets: a cache copy located on the online archive, and another copy located on removable media. After copying to removable media, no additional backup procedure is necessary, and the cache copy can be deleted from the online archive at the user's discretion. For example, if the archive server runs out of storage capacity, cache copies that have been also copied to removable media may be selected for deletion.

In the example shown in FIG. 5, the removable media comprises a CD. It should be noted that the removable media may be any type of removable media now known or future developed, and may include DVDs, magnetic tapes, flash memory drives, USB attached drives or FireWire attached drives.

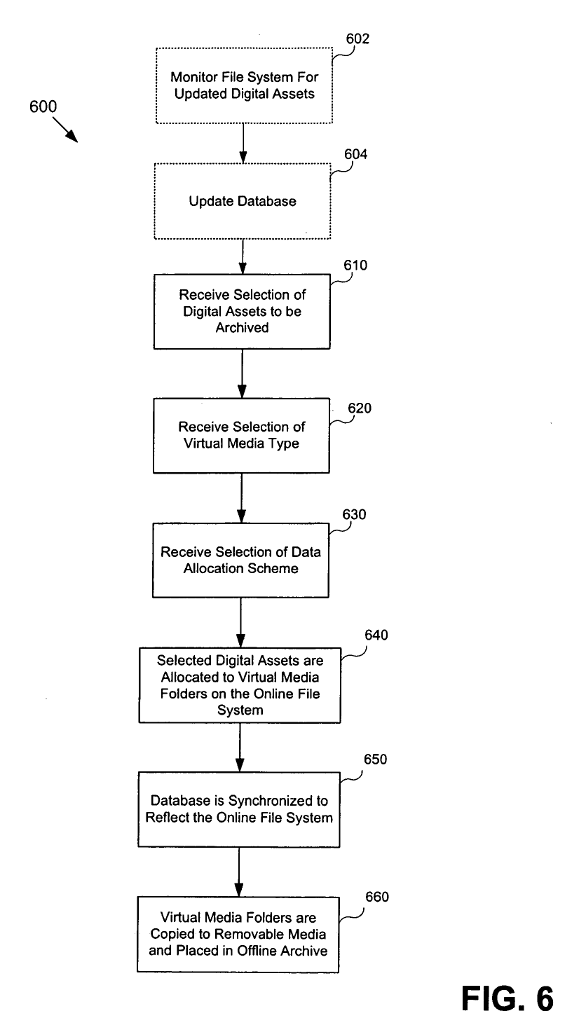

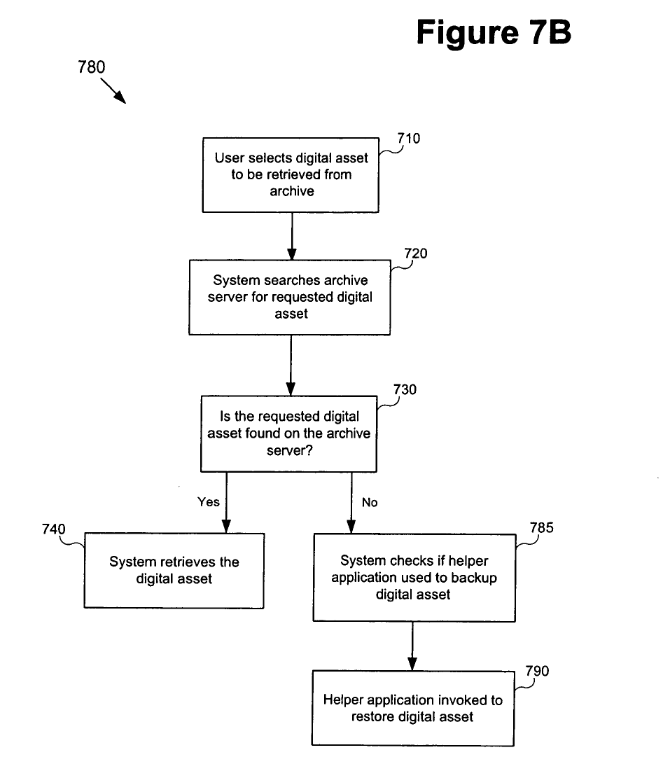

FIGS. 6 and 7 illustrate flow diagrams of methods for archiving and retrieving digital assets. The methods to be performed by the operating environment constitute computer programs made up of computer-executable instructions. Describing the methods by reference to a flowchart enables one skilled in the art to develop such programs including such instructions to carry out the methods on suitable computers (the processor or processors of the computer executing the instructions from computer-readable media such as ROMs, RAMs, hard drives, CD-ROM, DVD-ROM, flash memory etc. The methods illustrated in FIGS. 6 and 7 are inclusive of acts that may be taken by an operating environment executing an example embodiment of the invention.

Referring to FIG. 6, archive process 600 illustrates an exemplary storage and archive operation using the digital storage management system according to embodiments of the present invention. For purposes of the following description of archive process 600, reference will be made to pre-archive database 410 and post-archive database 450 of FIGS. 4a and 4b, respectively.

In those embodiments incorporating a file system monitor, the method executes blocks 602 and 604, where a file system is monitored for updates. In some embodiments, the file system may be periodically scanned to determine if digital asset files have been updated or created. For example, a creation or update timestamp associated with a file may be compared to the last scan time to determine if the digital asset file has been updated. In alternative embodiments where a journaling file system is used, a file system journal may be read to determine which digital asset files have been updated or created.

In some embodiments, a template may be used to filter which digital asset files are monitored. The template may specify a pattern that the file name or path must match in order to be monitored. The pattern may be specified using alphanumeric characters that are valid for a file name. In addition, the pattern may be specified using regular expressions, and wildcard characters.

At block 604, a database is updated with information regarding the created or updated digital asset files. As discussed above, this information includes the file location or path, the file name, file size, and other associated data.

At block 610, the system receives a selection of digital assets that are to be moved from production to archive. For example, A user could select folder 1-Brochure, folder 2-Label, and file 3-Chart.xls for archive on the archive server. Once a user selects the digital assets for archive, the system prompts the user to select a destination folder on the archive server and presents the user with a choice of archive parameters. As described above, the archive parameter selection screen can include archiving parameters such as the virtual media type and the data allocation scheme.

At block 620, the system receives a selection of the virtual media type from among the given options. Examples of media type options include 650 Mb CD, 700 Mb CD, 750 Mb CD, and 4.7 Gb DVD. Alternatively, the system may receive a selection of a helper application in order to archive the selected files.

Next, at block 630, the system receives a selection of the data allocation scheme which determines how the selected digital assets will be allocated across the selected media. Although archive process 600 has been described with two archive parameters (media type and data allocation scheme), various embodiments of the present invention can include other archive parameters in varying combinations and such parameters are within the scope of the inventive subject matter.

At block 640, the selected digital assets are allocated to virtual media folders based on the archive parameters chosen at blocks 620 and 630. The virtual media folders are now on the online file system, e.g. archive server.

At block 650, the database is automatically synchronized to reflect the organization of the virtual media folders as they appear on the online file system.

Finally, at block 660, the virtual media folders are copied from the file system, e.g. archive server, to removable media that comprise an offline archive. The type of removable media used at block 660 corresponds to the virtual media type chosen at block 620 so that each of the virtual media folders are virtual representations of the corresponding removable media objects in the offline archive. For example, if the user selects 700 Mb CD as the virtual media type at block 620, then at block 660 the user will copy the virtual media folders to 700 Mb CDs. These CDs can comprise an offline archive such as a media storage cabinet. In addition to CDs, the removable media may include DVDs, magnetic tape, flash memory devices, USB attached storage, or FireWire attached storage.

The functionality provided by the database used in embodiments of the present invention also improves the speed and efficiency of digital asset retrieval from offline archive. Referring to FIG. 7A, retrieval process 700 illustrates an exemplary retrieval operation using the digital storage management system according to embodiments of the present invention. For purposes of the following description of retrieval process 700, reference will be made to pre-archive database 410 and post-archive database 450 of FIGS. 4a and 4b, respectively.

The retrieval process begins with block 710, in which the user selects the digital asset that is to be retrieved from archive. As previously mentioned, a digital asset archived in accordance with some embodiments of the present invention may have two file paths that are stored in the database: a file path on the online file system (i.e. file server path) and a file path on the virtual media folder (i.e. media path). At block 720, the system searches the archive server for the requested digital asset. If the system finds the digital asset on the archive server, at block 740 the system retrieves the digital asset and the user can access and alter the digital asset as if it were in production. If the requested digital asset is not found on the archive server, at block 750 the system checks the media path of the digital asset. The media path indicates the name of the removable media object that contains the digital asset, e.g. CD_002. The user is then prompted to insert the removable media CD labeled CD_002. At block 760, the user obtains the removable media, e.g. CD_002, and inserts it into the computer drive. The user can now access the requested digital asset as well as any other digital assets contained on CD_002.

In alternative embodiments, a single archive path is stored in the database. Because the virtual media folder name is the same as a removable media label, the same path may be interpreted as either a file location on a volume of an archive file server, or as a path from a mount point for a removable archive media containing the file.

In some embodiments, at block 770, the system mounts the removable media at a folder in the archive file system designated as the mount point. For example, the virtual media folder may be used as a mount point. The root of the file system on the removable media is mounted to archive file system at the virtual media folder mount point. Thus access location specification provided in the database may remain the same regardless of whether the digital asset files physically reside on the archive server or on the removable media.

Thus, the system provides the user with the removable media location of the requested digital asset. Thus, the digital storage management system according to embodiments of the present invention keeps track of the location of all digital assets whether online or offline.

For example, assume that a user wants to retrieve the file “Labelpic2.tiff” shown in post-archive database 450 of FIG. 4b. Post-archive database 450 indicates that Labelpic2.tiff is located on the destination volume “NAS1” on the file server. Furthermore, post-archive database 450 indicates that Labelpic2.tiff is also located within folder “2-Label” on a 700 Mb CD labeled “CD_002.” First, the system follows the file server path and searches volume “NAS1” for Labelpic2.tiff in the virtual media folder labeled “CD_002” resulting in a file path of “NAS1:\\CD_002\2-Label\labelpic2.tiff.” However, the file Labelpic2.tiff may no longer exist at the location specified by the file server path because the file may have been removed from the archive server. In that case, the system will see from database 450 that Labelpic2.tiff is located on removable media CD_002, and will prompt the user to insert this CD. Once inserted, the system will search CD_002 for Labelpic2.tiff, using the media path “2-Label\Labelpic2.tiff.” If the removable media is not inserted or the file is not found on the media, then the system may generate an error message.

FIG. 7B illustrates a method 780 for retrieving digital assets according to alternative embodiments of the invention. Tasks represented by blocks 710-740 are substantially the same as described above with respect to FIG. 7A. At block 785, the system determines if a helper application was used to archive the digital asset if the digital asset is not available on an archive server. As discussed above, the helper application may be an application that manages backups to tape backup media. Alternatively, the backup media managed by the helper application may utilize CDs, DVDs, flash memory or other persistent storage device.

At block 790, the helper application may be invoked to manage the restoration of a file or files representing digital assets. The files may be restored to a user selected directory or folder, or they may be restored to their original directory or folder on an archive or production server. In some embodiments, the helper application creates a “job file” that provides parameters that describe how the file or files are to be restored. In addition, the restoration may take place when the helper application is invoked, or may be scheduled to occur at a future time.

As described above, the digital storage management system according to embodiments of the present invention provides a system and method for efficient archiving and retrieval of digital assets that overcomes the disadvantages of conventional archive and retrieval systems. As a user archives digital assets, the system allocates the digital assets into virtual media folders in a manner that is specified by the user and customized for storage on removable media. The archived digital assets are automatically labeled and organized in the database as if they already exist on removable media. When the virtual media folders are copied to removable media, the folder structure under the virtual media folder may be replicated.

Thus, two copies of the digital assets may be located in archive: a cache copy located in the user-selected destination folder on the online archive, and another copy located on removable media. In some embodiments, the file paths corresponding to these two locations, i.e. a file path on the online archive file system (i.e. file server path) and a file path on the virtual media folder (i.e. media path), are stored on the database. In alternative embodiments, a single path is stored, which may be interpreted as a location on an archive server or as a path through a mount point for a removable media. In either case, no additional backup procedure is necessary, and the cache copy on the archive server can be deleted either automatically or at the user's discretion.

The Abstract is provided to comply with 37 C.F.R. § 1.72(b) to allow the reader to quickly ascertain the nature and gist of the technical disclosure. The Abstract is submitted with the understanding that it will not be used to limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus the following claims are hereby incorporated into the Detailed Description, with each claim standing on its own as a separate embodiment.

The foregoing descriptions of specific embodiments of the present invention have been presented for purposes of illustration and description. The embodiments presented are not intended to be exhaustive or to limit the invention to the particular forms disclosed. It should be understood that one of ordinary skill in the art can recognize that the teachings of the detailed description allow for a variety of modifications and variations that are not disclosed herein but are nevertheless within the scope of the present invention. Accordingly, it is intended that the scope of the present invention be defined by the appended claims and their equivalents, rather than by the description of the embodiments.

What is claimed is:

1. A method comprising:
receiving a selection of a physical media size;
receiving a selection of a set of one or more files on a first file server;
creating a set of one or more virtual media folders on a second file server; and
copying the set of one or more files to the set of one or more virtual media folders such that the size of files copied to a virtual media folder does not exceed the physical media size.

2. The method of claim 1, further comprising copying one or more of the files in a virtual media folder to a corresponding removable physical media.

3. The method of claim 2, further comprising labeling the removable physical media with a name of the virtual media folder.

4. The method of claim 2, further comprising maintaining a database including metadata regarding each file in the set of one or more files, said metadata specifying at least one location of the set of one or more files, said location comprising a location on the first file server, a virtual media folder on the second file server, or the corresponding removable physical media.

5. The method of claim 4, wherein the metadata includes an archiving status, and further comprising updating the archiving status for the set of one or more files to indicate that the set of one or more files have been copied to the removable physical media.

6. The method of claim 4, wherein the metadata includes a media label field, and further comprising updating the media label field with the media label for the removable physical media.

7. The method of claim 2, wherein the physical media size corresponds to a CD-ROM.

8. The method of claim 2, wherein the physical media size corresponds to a DVD-ROM.

9. The method of claim 2, further comprising receiving a selection of a helper application and wherein copying one or more files in a virtual media folder includes invoking the helper application to copy the one or more files.

10. The method of claim 2, wherein the removable physical media is selected from the group consisting of CD, DVD, magnetic tape, flash memory drive, USB attached drive or FireWire attached drive.

11. The method of claim 1, wherein copying the set of one or more files to the set of one or more virtual media folders utilizes a data allocation scheme that minimizes the number of virtual media folders required to contain the set of one or more files.

12. The method of claim 1 wherein the set of one or more files includes a folder containing at least a subset of the one or more files and wherein copying the set of one or more files to the set of one or more virtual media folders utilizes a data allocation scheme that does not split the subset of the one or more files across more than one virtual media folder.

13. A method comprising:
receiving a request to access a file;
reading at least one database entry associated with the file to determine a location of the file;
determining if the file exists at the location; and
if the file does not exist at the location, obtaining a backup media storing the file.

14. The method of claim 13, wherein obtaining the backup media comprises:
reading a media label from the at least one database entry; and
providing a prompt to load the backup media having the media label.

15. The method of claim 13, wherein obtaining the backup media comprises loading the backup media from a media jukebox.

16. The method of claim 13, wherein the backup media is selected from the group consisting of CD, DVD, magnetic tape, flash memory drive, USB attached drive or FireWire attached drive.

17. The method of claim 13, wherein obtaining the backup media includes invoking a helper application.

18. A system comprising:
a file server;
an archive server; and
a client application operable to:
receive a selection of a physical media size;
receive a selection of a set of one or more files on the file server;
create a set of one or more virtual media folders on the archive server; and
copy the set of one or more files to the set of one or more virtual media folders such that the size of files copied to a virtual media folder does not exceed the physical media size.

19. The system of claim 18, further comprising a database including metadata regarding each file in the set of one or more files, said metadata specifying at least one location of the set of one or more files, said location comprising a location on the first file server, a virtual media folder on the second file server, or a corresponding removable physical media.

20. The system of claim 19, wherein the metadata includes an archiving status, and further comprising updating the archiving status for the set of one or more files to indicate that the set of one or more files have been copied to the removable physical media.

21. The system of claim 19, wherein the metadata includes a media label field, and further comprising updating the media label field with the media label for the removable physical media.

22. The system of claim 19, wherein the database is a relational database.

23. The system of claim 18, wherein the physical media size corresponds to a CD-ROM.

24. The system of claim 18, wherein the physical media size corresponds to a DVD-ROM.

25. The system of claim 18, wherein the removable physical media selected from the group consisting of CD, DVD, magnetic tape, flash memory drive, USB attached drive or FireWire attached drive.
